(19) United States
(12) Patent Application Publication
(10) Pub. No.: US 2005/0045246 A1
(43) Pub. Date: Mar. 3, 2005

(54) Holding device for panel door milling

(76) Inventor: Wayne Jacob Gregoire, Eden Prairie, MN (US)

Correspondence Address: Wayne J. Gregoire, 12771 Gordon Drive, Eden Prairie, MN, 55346, US

(21) Appl. No.: 10/923,456

(22) Filed: Aug. 21, 2004

Related U.S. Application Data
(60) Provisional application No. 60/498,538, filed on Aug. 28, 2003.

(51) Int. Cl. B27C 1/00; B27C 5/00

(52) U.S. Cl. 144/114.1

(57) ABSTRACT

A holding device (10), comprised of a base (12), handle (48), and overhead/guide guard (26) for precision processing of a work piece (66) on a wood shaper (38). A machine operator can load a work piece (66) onto a wood shaper (38) and hold the work piece (66) by means of a the holding device (10). The operator moves the holding device (10) along a processing machine fence guide (46) while engaging the overhead guide/guard (26) continuously with the processing machine fence guide (46). Comprised of an adjustable sacrifice stick (34), the operator makes adjustment to the prawls (50) to move and replenish the sacrifice stick (34).

### BACKGROUND OF THE INVENTION

The present invention relates generally to the edge milling of panel constructed cabinet doors on a wood shaper milling machine. The use of hand feeding pieces through a shaper is representative of the prior art existing in this field of cabinet processing. Hand processing is dependent on operator skill. Chipping, dips and wavy cuts are examples of circumstances that can occur. This method of processing does not solve the problem of high precision processing of cabinet doors with accuracy, safety, speed and consistent results.

From the above, it can be seen what is needed is a holding device for panel door milling with a greater degree of operator ease, less operator skill, safety, more economical and consistent results, on a wood shaper.

### OBJECTIVES

The primary object of this invention is the precision processing and feeding of panel doors and other stock material and to provide a holding apparatus for precision processing of material on a wood shaper.

A more specific object of the present invention is to universally adapt to already existing wood shapers.

Another object of the present invention is the ability to deliver a portable system of material holding and handling to existing wood shapers.

Another object of the present invention is to control stability of the work piece while it is being processed.

Another object of the present invention is to deliver a work piece to the machine cutter with controlled precision.

Another object of the present invention is to provide solidarity to hand held options for the work piece.

Another object of the present invention is to provide rigidity in positioning and holding options for the work piece.

Another object of the present invention is to provide a more stable means to process the work piece.

Another object of the present invention is to receive a higher degree of safety for the machine operator.

Another object of the present invention is to provide improved visibility of the process for the machine operator.

Another object of the present invention is to produce precision consistent results, efficient use of the operators time or reduce operator stress. Kick back, potential for injury, is reduced.

Another object of the present invention is to eliminate cutter marks and chatter, the use of waxes, chipping, splitting, tear and blow out of the work piece.

Another object of the present invention is the elimination of waste and improved performance of the machine on which it is used.

Another object of the present invention is to accommodate normal cutting and shaping and precession processing of stock materials in the form of small panels.

Another object of the invention is to keep the operators hands away from the cutters, when cutting.

Another object of the invention is to allow operators view of cut in progress.

Another object of the invention is to eliminate the use of a miter slot.

### SUMMARY OF THE INVENTION

The present invention is a holding device for precision processing of panel doors and material on a wood shaper. Typically this power tool is used in wood working shops by professionals and amateurs. This tool is used to process other materials as well. As a result of the use of this holding device, material processing precision and operating conditions are greatly improved.

In the preferred embodiment, the assembly features a portable platform universally adaptable to various types of wood shapers. The present invention, which is operator controlled, allows for loading and precision placement of a work piece in a controlled and rigid holding environment. The machine operator is then able to move the work piece through the cutting operation in a positively engaged way with high visibility and with a greater degree of operator safety. The assembly features a platform base, handle, overhead guide/guard and compatibility with other manufacturers equipment.

### BRIEF DESCRIPTION OF THE DRAWINGS

In order that the invention may be clearly understood and readily carried into effect, a preferred embodiment of the invention will now be described, by way of example only, with reference to the accompanying drawings wherein:

All Figures are drawn for ease of explanation of the basic teachings of the present invention only; the extensions of the Figures with respect to number, position, relationship, and dimensions of the parts to form the preferred embodiment will be explained or will be within the skill of the art after the following description has been read and understood. Further, the exact dimensions and dimensional proportions to conform to specific force, weight, strength and similar requirements will likewise be within the skill of the art after the following description has been read and understood.

Where used in the various figures of the drawings, the same numerals designate the same or similar parts. Furthermore, when the terms “inner”, and “outer”, and similar terms are used herein, it should be understood that these terms have reference only to the structure shown in the drawings as it would appear to a person viewing the drawings and are utilized only to facilitate describing the preferred embodiments.

FIG. 1 is a perspective view of the holding device in use on a wood shaper.

FIG. 2 is a plan view of the holding device.

FIG. 3 is a bottom view of FIG. 2.

### DETAILED DESCRIPTION OF THE INVENTION

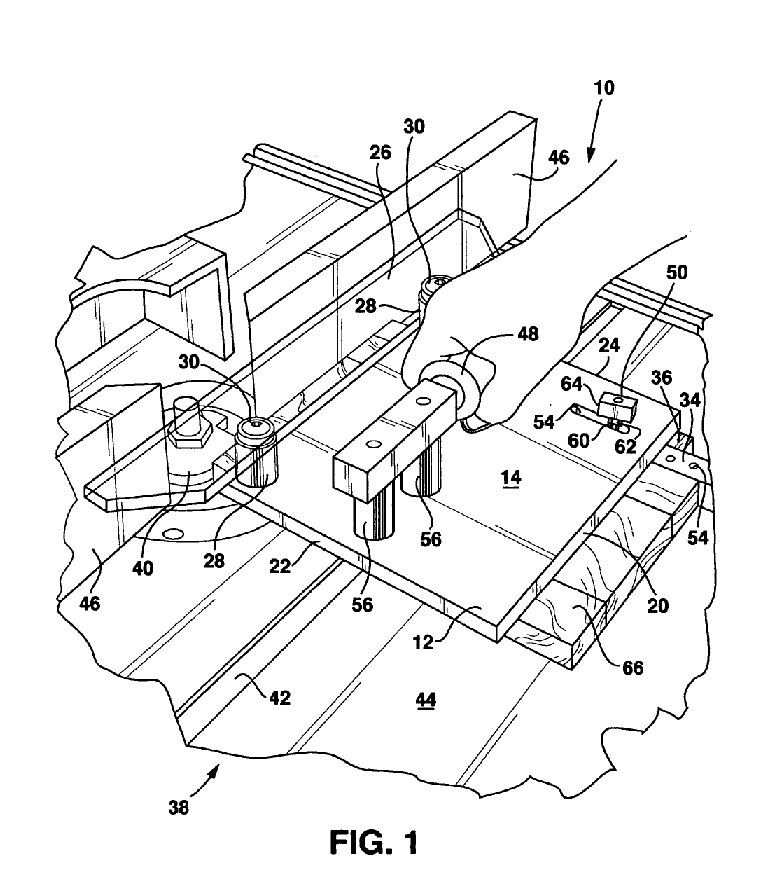

FIG. 1 is a perspective view of the holding device 10, in use. It is comprised of a platform base 12 made from 0.50 inch thick Mic 6 aluminum plate. The platform base 12 has a top 14, a bottom 16, a front 18, a back 20, a left side 22 and a right side 24.

An operator sets holding device 10 on top of a work piece 66 engaged to a sacrifice stick 34. The holding device 10 engages the work piece 66 by friction contact with textured non slip surface film 32 and base bottom 16. The operator, by the use of adjustable handle 48 moves the holding device 10 through it's contact with wood shaper cutter 40 by constant forward moving pressure with a primary point of contact being the engagement of a overhead guide/guard 26 with a wood shaper fence guide 46. The holding device 10 is glided across a wood shaper table surface 44 without any engagement into miter slot 42. A sacrifice stick 34 is consumed at the end of the cut to avoid blow out or chipping.

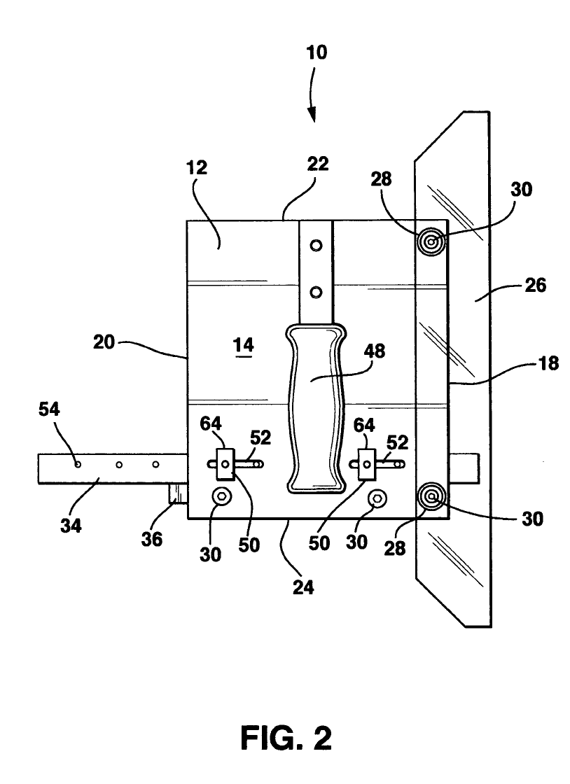

FIG. 2 is a plan view of the holding device 10. An overhead guide /guard 26 is made from 0.50 inch clear poly carbonate sheet such as GE brand Lexan. Oversized fastening holes are drilled to accommodate button head cap screws 30 which fixes the guide/guard 26 to guide/guard towers 28. This is done to accommodate final squaring and alignment with a wood shaper fence guide 46. Guide/guard towers 28 are affixed to the top of platform base 12 by flat head socket cap screws 58 inserted though the bottom 16 of base 12.

Adjustable handle 48 is affixed through the bottom 16 of base 12 by two screws 58 which extend through handle support columns 56.

Two platform slots 52 are placed in platform 12 to accommodate prawls 50. Prawls 50 are comprised of hanger studs 60, self locking nuts 62 and knob 64. Prawls 50 thread into pre drilled mounting holes 54 in a sacrifice stick 34. Sacrifice stick 34 is made of wood or plastic such as UHMW Polyethylene.

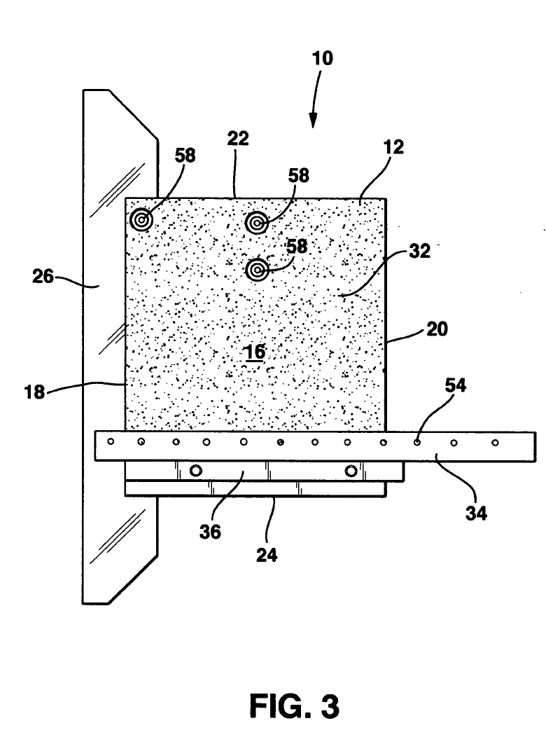

FIG. 3 is a bottom view of FIG. 2. Attached to the bottom 16 of base 12 is a fixed guide bar 36. Fastened by two button head socket cap screws 30. The bottom 16 is also covered with a textured non slip surface film 32, such as, 610 Safety Walk General Purpose Tread Material, N.048011-19224 by 3M Company, as a traction surface.

While the above description contains many specificties, these should not be construed as limitations on the scope of the invention, but rather as an exemplification of one preferred embodiment thereof. Many other variations are possible such as additional numbers of prawls, plates, extrusions, automation, other proportional and dimensional configurations, various use of materials in construction, pluralities of work pieces, handles, knobs and use on all types of processing equipment.

Accordingly, the scope of the invention should be determined not by the embodiments illustrated, but by the appended claims and their legal equivalents.

### Reference Numerals

10 Holding Device
12 Platform Base
14 Platform Base Top
16 Platform Base Bottom
18 Plafform Base Front
20 Platform Base Back
22 Plafform Base Left Side
24 Platform Base Right Side
26 Overhead Guide/Guard
28 Guide/Guard Towers
30 Button Head Socket Cap Screws
32 Textured Non Slip Surface Film
34 Sacrifice Stick
36 Fixed Guide Bar
38 Wood Shaper
40 Wood Shaper Cutter
42 Miter Slot
44 Wood Shaper Table Surface
46 Wood Shaper Fence Guide
48 Adjustable Handle
50 Prawls
52 Platform Slots
54 Sacrifice Stick Mounting Holes
56 Handle Support Columns
58 Flat Head Socket Cap Screws
60 Hanger Studs
62 Self Locking Nuts
64 Knob
66 Work Piece

1. A holding device for work piece milling on a wood shaper, comprising:
a. a holding apparatus for the work piece.

2. A holding apparatus for work piece milling on a wood shaper, comprising:
a. a platform having a textured non slip bottom surface,
b. a handle.
c. a overhead guide/guard.
d. means for holding a sacrifice stick and a work piece,
whereby said platform can be moved along a fence of a wood shaper.

3. The holding device for work piece milling of claim 2 comprising:
a. a holding apparatus and work piece engaged to a wood shaper, and
b. a holding means allowing a panel door to be processed.
c. a holding means allowing a work piece less then 3 inches height and width to be processed.

4. The holding device for work piece milling of claim 2 comprising:
a. a holding apparatus and engaged to a wood shaper with stacked cutters.
b. a direct means for preventing use of a miter slot
c. a direct means to eliminate work piece gauging and chipping.

5. The holding apparatus of claim 2 comprising:
a. a platform base and
b. textured non slip bottom surface.
c. a top surface supporting a plurality of utilities.
d. a fixed guide bar.

6. The clamping apparatus of claim 2 comprising:
a. a adjustable handle and
b. comfort means for the operator.

7. The holding apparatus of claim 2 comprising:
a. a over head guide/guard and
b. squaring means to the cutters.
c. a shield preventing flying cutting debris from hitting operator.
d. a shield allowing view of the cut in progress.
e. a shield preventing operators hands from contacting cutters.

8. The holding apparatus of claim 2 comprising:
a. a adjustable means to hold a sacrifice stick.
b. a means to prevent chipping and blow out of the work piece.
c. a means for quick adjustment of the sacrifice stick.
